(19) United States
(12) Patent Application Publication
(10) Pub. No.: US 2024/0102867 A1
(43) Pub. Date: Mar. 28, 2024

(54) SYSTEMS AND METHODS TO ADDRESS ENVIRONMENTALLY EXPOSED SURFACES

(71) Applicant: Ford Global Technologies, LLC, Dearborn, MI (US)

(72) Inventors: Michelle Yi, Sterling Heights, MI (US); Mahmoud Yousef Ghannam, Canton, MI (US); John Robert Van Wiemeersch, Novi, MI (US)

(73) Assignee: Ford Global Technologies, LLC, Dearborn, MI (US)

(21) Appl. No.: 17/936,274

(22) Filed: Sep. 28, 2022

(51) Int. Cl. G01K 3/00; B60H 1/00

(52) U.S. Cl. CPC G01K 3/005; B60H 1/00878

(57) ABSTRACT

The disclosure is generally directed to systems and methods to address surfaces of a vehicle that are uncomfortable to the touch. An example method executed by a processor includes determining a surface temperature of a component of the vehicle, determining that the surface temperature exceeds a threshold surface temperature, and issuing a notification based on the surface temperature of the component exceeding the threshold surface temperature. Determining the surface temperature of the component can involve operations such as measuring the surface temperature, estimating the surface temperature, and/or predicting the surface temperature. Measuring the surface temperature can involve obtaining a temperature measurement from a thermal sensor. Estimating the surface temperature can involve operations such as evaluating a thermal image of at least a portion of the component, evaluating an ambient temperature, and/or evaluating sunlight exposure. Predicting the surface temperature can include operations such as evaluating predicted weather information and/or evaluating historical vehicle parking information.

### BACKGROUND

Various parts of a vehicle that is parked at a location exposed to direct sunlight can become uncomfortable to the touch. Many surfaces of a vehicle will vary in temperature depending on its exposure to environmental conditions such as sunlight. In some cases, a component of the vehicle that has been exposed to sunlight for a significant amount of time may feel warmer than normal due to the effects of extended exposure to direct sunlight. It is therefore desirable to address this.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 shows an example vehicle that includes a surface temperature detection and notification system in accordance with an embodiment of the disclosure.

FIG. 2 illustrates a cabin area of an example vehicle that includes a surface temperature detection and notification system in accordance with an embodiment of the disclosure.

FIG. 3 illustrates a flowchart of an example procedure to address a surface in a vehicle that are uncomfortable to the touch in accordance with an embodiment of the disclosure.

FIG. 4 shows an example table of temperature ranges and notification levels in accordance with an embodiment of the disclosure.

FIG. 5 illustrates an example thermal map in accordance with an embodiment of the disclosure.

FIG. 6 shows an example display that includes some thermal zones in accordance with an embodiment of the disclosure.

FIG. 7 illustrates a flowchart of an example procedure to address an uncomfortably temperature of an enclosure of an infotainment system in a vehicle in accordance with an embodiment of the disclosure.

FIG. 8 illustrates a flowchart of an example procedure to address a display screen of an infotainment system in a vehicle that has become uncomfortable to the touch in accordance with an embodiment of the disclosure.

FIG. 9 illustrates some example components that can be included in a vehicle in accordance with an embodiment of the disclosure.

### DETAILED DESCRIPTION

### Overview

In terms of a general overview, embodiments described in this disclosure are generally directed to systems and methods to address uncomfortable to the touch surfaces of a vehicle. An example method executed by a processor of a surface temperature detection and notification system includes determining a surface temperature of a component of a vehicle and issuing a notification based on the surface temperature of the component exceeding a threshold surface temperature. In some cases, a cooling operation may be initiated for reducing the surface temperature of the component. Determining the surface temperature can involve measuring the surface temperature of the component, estimating the surface temperature of the component, and/or predicting the surface temperature of the component. Measuring the surface temperature of the component can involve obtaining a temperature measurement from a thermal sensor. Estimating the surface temperature of the component can involve evaluating a thermal image of at least a portion of the component, evaluating an ambient temperature, and/or evaluating sunlight exposure. Predicting the surface temperature of the component can include evaluating predicted weather information and/or historical vehicle parking information.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the word “information” as used herein pertains to any of various forms of data that can be processed by a processor (digital data, digital images, detector signals, etc.). Words such as “image,” or “graphical rendering” as used herein can pertain to a single image in a first example scenario, a set of images in a second example scenario, a video clip in a third example scenario, and real-time video in a fourth example scenario.

The word “sensor” as used herein refers to any device than may be used for various purposes such as to obtain information about an object, to detect the presence of an object, and/or to detect actions performed by an individual. More particularly, a sensor as used herein, may, in various implementations, be used to detect, sense, determine, and/or measure a temperature of an object in a vehicle. Words such as “component,” “object” and “item” can be used in this disclosure in an interchangeable manner. The word “vehicle” as used in this disclosure can pertain to any of various types of vehicles, including ground vehicles (such as, for example, cars, vans, sports utility vehicles, trucks, electric vehicles, gasoline vehicles, and hybrid vehicles), water vehicles (such as, for example, boats, yachts, and ships), and air vehicles (such as, for example, various types of aircraft).

It must be understood that words such as “implementation,” “application,” “scenario,” “case,” and “situation” as used herein are an abbreviated version of the phrase “In an example (“implementation,” “application,” “scenario,” “case,” “approach,” and “situation”) in accordance with the disclosure.” It must also be understood that the word “example” as used herein is intended to be non-exclusionary and non-limiting in nature.

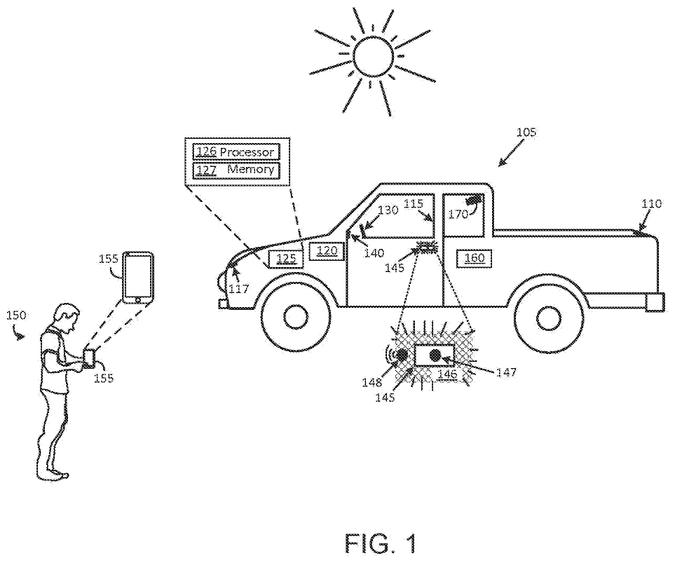

FIG. 1 shows a vehicle 105 that includes a surface temperature detection and notification system 125 in accordance with an embodiment of the disclosure. The vehicle 105 may further include components such as, for example, a vehicle computer 120, a sensor system 160, and an infotainment system 140. These components may be communicatively coupled to the surface temperature detection and notification system 125 via a wired communication system and/or a wireless communication system.

The description provided herein is with reference to the vehicle 105 that is illustrated in example form as a truck. However, it must be understood that the description is equally applicable to various other types of vehicles (sedan, van, sports utility vehicle, forklift, etc.). Thus, for example, a description pertaining to the surface temperature detection and notification system 125 with respect to detecting and providing a notification related to a surface temperature of a part of the truck such as, for example, a door handle 145 or the infotainment system 140, is equally applicable to a similar part in a sedan or a van.

The vehicle computer 120 may perform various functions of the vehicle 105, such as, for example, controlling engine operations (fuel injection, speed control, emissions control, braking, etc.), managing climate controls (air conditioning, heating etc.), activating airbags, and issuing notifications (check engine light, bulb failure, low tire pressure, etc.). The vehicle computer 120 may also provide various types of information to the surface temperature detection and notification system 125, such as, for example, thermal information pertaining to various components of the vehicle 105. The thermal information can include, for example, a temperature setting of an air-conditioning (AC) system of the vehicle 105 and/or an ambient temperature in a cabin area of the vehicle 105.

The infotainment system 140 can include a touch screen that may be operated upon by an occupant of the vehicle 105 such as, for example, to obtain navigation assistance. In this application, a driver (not shown) of the vehicle 105 may touch various icons upon the touch screen to initiate a request for navigation assistance. In an example scenario, a surface of the touch screen may become uncomfortable to the touch when the vehicle 105 is parked at a location exposed to direct sunlight. The surface temperature detection and notification system 125 is configured to determine the surface temperature of the touch screen and execute various actions in accordance with the disclosure. The actions can include, for example, initiating a cooling operation to cool the surface of the touch screen and/or issuing a notification about the temperature of the surface of the touch screen.

The sensor system 160 can include one or more of various types of devices that are configured to sense, detect, determine, and/or measure the temperature of various components of the vehicle 105. In an example implementation, the sensor system 160 can include a thermocouple, a thermistor, a semiconductor integrated circuit (IC) sensor, and/or a thermometer. Such devices can be mounted adjacent to, or integrated into, various components of the vehicle 105. Thus, for example, a thermistor may be arranged in contact with a touch screen of the infotainment system 140 for measuring a surface temperature of the touch screen. The surface temperature information may be conveyed to the surface temperature detection and notification system 125 through a wired communication medium and/or via a wireless network.

In another example implementation, the sensor system 160 can include one or more cameras such as, for example, a digital camera, a video camera, and/or a thermal imaging device. The digital camera may be used for capturing various images such as, for example, an image of an individual 150 who is present in the vicinity of the vehicle 105.

An example of a thermal imaging device is a thermal imaging camera 170 that is shown in the cabin area of the vehicle 105. The thermal imaging camera 170 may be mounted at various other locations on the vehicle 105, including, at locations suitable for capturing thermal images of exterior portions of the vehicle 105 (doors, trunk, hood, etc.). The thermal images can be conveyed to the surface temperature detection and notification system 125 through a wired communication medium and/or via a wireless network. The surface temperature detection and notification system 125 may evaluate the thermal images to determine a surface temperature of a component of the vehicle 105 such as, for example, to determine a surface temperature of the touch screen of the infotainment system 140.

The sensor system 160 can also include various devices configured to capture various types of temperature information, such as, for example, a device that detects an ambient temperature outside the vehicle 105, a device that detects an ambient temperature in the vicinity of a component of the vehicle 105, a device that obtains location information of a parking spot in which the vehicle 105 is parked, and a device that obtains sunlight exposure information (direct exposure, in shade, length of time of exposure, etc.). Ambient temperature outside the vehicle 105 may be dependent on various factors such as, for example, a time of day, a season of the year, local weather, temperature in the vicinity of the vehicle 105, global positioning (latitude) and weather conditions at a location where the vehicle 105 is parked (sunny, rainy, cloudy, etc.).

Information provided by such devices of the sensor system 160 may be evaluated by the surface temperature detection and notification system 125 for determining a surface temperature of a component of the vehicle 105 (such as, for example, for determining a surface temperature of the door handle 145 and/or of a touch screen of the infotainment system 140).

More particularly, a processor 126 of the surface temperature detection and notification system 125 is configured to access a memory 127 and execute computer-executable instructions stored in the memory 127 to perform various operations in accordance with the disclosure such as, for example, a temperature measurement operation, a temperature estimation operation and/or a temperature prediction operation.

The temperature measurement operation is generally directed at determining the surface temperature of a component based on temperature information provided to the surface temperature detection and notification system 125 by temperature sensing devices (a thermistor, a thermocouple, etc.). In an example implementation, the processor 126 may determine a surface temperature of a touch screen of the infotainment system 140 either directly or indirectly. A direct determination may be made based on a temperature measurement provided by a thermal sensor coupled to the surface of the touch screen. An indirect determination may be made by evaluating a temperature measurement provided by a thermal sensor coupled to an enclosure of the infotainment system 140 (a housing, a metal box, or a module, for example) and/or a temperature measurement provided by a temperature probe arranged to measure an ambient temperature of a cabin area of the vehicle 105.

The temperature estimation operation is generally directed at estimating the surface temperature of the component based on evaluating various types of information such as for example, a thermal image provided by the thermal imaging camera 170, an ambient temperature outside the vehicle 105, an ambient temperature in the vicinity of the component (the door handle 145, for example), sunlight exposure, length of sunlight exposure, an ambient temperature based on various factors (such as, for example, time of day, season, and parking location), weather conditions at a location where the vehicle 105 is parked, and/or thermal characteristics (temperature coefficient, for example) of a material composition of the component.

The temperature prediction operation is generally directed at predicting the surface temperature of the component at a future instant in time such as, for example, when a driver is expected to return to the vehicle 105 after a period of time. In an example scenario, the period of time can correspond to a typical workday, and the future instant in time can correspond to a time in the evening when the driver finishes work and returns to the vehicle 105 to head back home (5:30 PM, for example).

In this approach, a surface temperature of a component of the vehicle 105 may be predicted based on evaluating various types of information such as for example, predicted weather information (weather forecast, historical weather, etc.), an expected change in temperature outside the vehicle, an expected amount of daylight and/or sunlight, historical data about vehicle driving and parking habits of the driver (historical vehicle parking information), an ambient temperature outside the vehicle 105 over a period of time before the driver returns to the vehicle, an ambient temperature in the vicinity of the component (the door handle 145, for example) over a period of time before the driver returns to the vehicle, and/or thermal characteristics (temperature coefficient, for example) of a material composition of the component.

In an example implementation, the surface temperature detection and notification system 125 can include a digital simulator system such as, for example, a real-time digital (RTD) simulator system, that can execute the temperature estimation operation and/or the temperature prediction operation described above. The RTD simulator system can incorporate various types of methodologies such as, for example, one or more algorithms, artificial intelligence, simulation, historical information, and statistical parameters. The RTD simulator may reside in the notification system 125 or the algorithm may be executed in a cloud-based service network with the predicted temperature result(s) then being downloaded to the vehicle.

The processor 126 may execute the temperature measurement operation, the temperature estimation operation, and/or the temperature prediction operation to determine a surface temperature of a component that is likely to be touched by an individual (driver, passenger, etc.) and is located on an exterior portion of the vehicle 105 and/or in a cabin area of the vehicle 105.

A component located on the exterior portion of the vehicle 105 is typically exposed directly to sunlight that can increase the surface temperature of the component. The driver-side door handle 145 is one example of such a component. Other example components can include a passenger side door handle, a tailgate latch 110, a hood latch 117, and a door jamb 115.

A component located in the cabin area of the vehicle 105 may be directly exposed to sunlight entering the cabin area via a window of the vehicle 105. The sunlight can increase the surface temperature of the component. The surface temperature of the component inside the cabin area may also increase as a result of air trapped inside the cabin area. The air can get heated by sunlight entering the cabin area. The steering wheel 130 is one example of such a component.

In an example procedure, the processor 126 may compare a surface temperature of a component to a threshold surface temperature and issue a notification to the individual 150 when the surface temperature exceeds the threshold surface temperature. The notification may be issued in various ways. In a first example scenario, the processor 126 may compare a surface temperature of the door handle 145 to a threshold surface temperature and issue a notification to the individual 150 when the surface temperature of the door handle 145 exceeds the threshold surface temperature.

In one example case, the processor 126 provides the notification by activating an example light source located below the door handle 145 and/or by activating another example light source (a light emitting diode (LED) 147, for example) located upon the door handle 145. The light source located below the door handle 145 can produce an illumination 146 around the door handle 145.

In another example case, the processor 126 provides the notification by activating an audio transmitter 148. The audio transmitter 148 may be configured, for example, to emit a beeping sound before the individual 150 reaches the vehicle 105 and touches the door handle 145. In another example case, the processor 126 may provide the notification by displaying a notification message on an externally viewable display before the individual 150 reaches the vehicle 105 and touches the door handle 145.

In yet another example case, the processor 126 provides the notification by sending a message to a personal device 155 carried by the individual 150. The message may be sent to the personal device 155 before the individual 150 reaches the vehicle 105 and touches the door handle 145. The personal device 155 can be any of various devices such as, for example, a smartphone, a tablet computer, a laptop computer, or a wearable device.

The door handle 145 is merely one example component that can be operated upon by the processor 126. Accordingly, the processor 126 may compare a surface temperature of any other component of the vehicle 105 to a threshold surface temperature and issue a notification to the individual 150 when the surface temperature exceeds the threshold surface temperature. The component can be located anywhere in the vehicle 105 and is typically a component that may be touched by the individual 150.

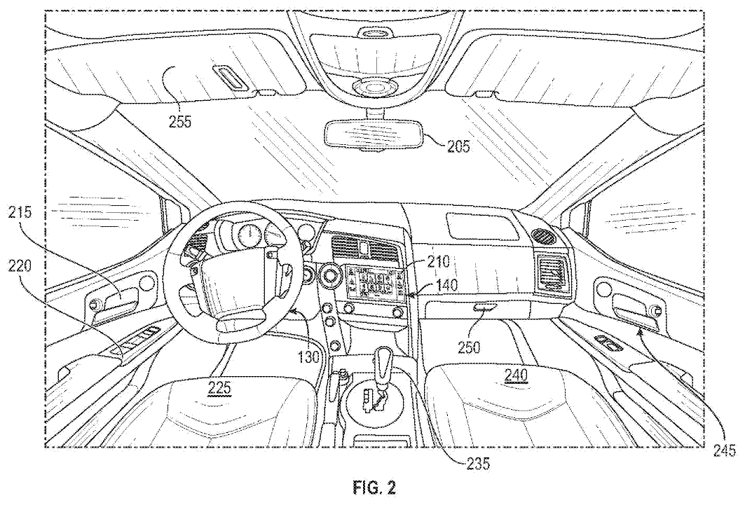

FIG. 2 illustrates a cabin area of the vehicle 105 that can include various components that can be operated upon by the surface temperature detection and notification system 125 in accordance with the disclosure. In an example implementation, the various components may be classified on the basis of a likelihood of being touched by an occupant of the vehicle 105. For example, a first set of components may be classified as belonging to a first component category. Each component in the first set of components has a high likelihood of being touched by an individual over a first period of time, either as the individual is entering the vehicle 105 or shortly thereafter.

A second set of components may be classified as belonging to a second component category. In comparison to the first set of components each component in the second set of components has a lower likelihood of being touched by an individual either as the individual is entering the vehicle 105 or shortly thereafter. These components may be touched by the individual over a second period of time that follows the first period of time. Additional sets and categories may be defined in a similar manner.

Some example components that may belong to the first set of components are the door handle 215 which may be used by a driver to close the driver-side door, a driver-side seat 225 on which the driver may sit upon entering the vehicle 105, the steering wheel 130, and the drive selector 235.

Some example components that may belong to the second set of components are the window activation switches 220, the rear-view mirror 205, and a touch screen 210 of the infotainment system 140.

Some example components that can belong to other component categories and may be touched by the driver over subsequent periods of time are the glove compartment handle 250 and the visor 255.

Components that may be touched by a passenger of the vehicle 105 can include the passenger-side seat 240 and the passenger-side door handle 245. Such components may also be classified in various categories. Other components may include an arm rest, dashboard, head rest/restraint, seat belt buckle, door lock, etc.

In an example embodiment, the processor 126 of the surface temperature detection and notification system 125 may be configured to operate upon the first set of components followed by operations upon subsequent sets of components in a sequential order based on priority.

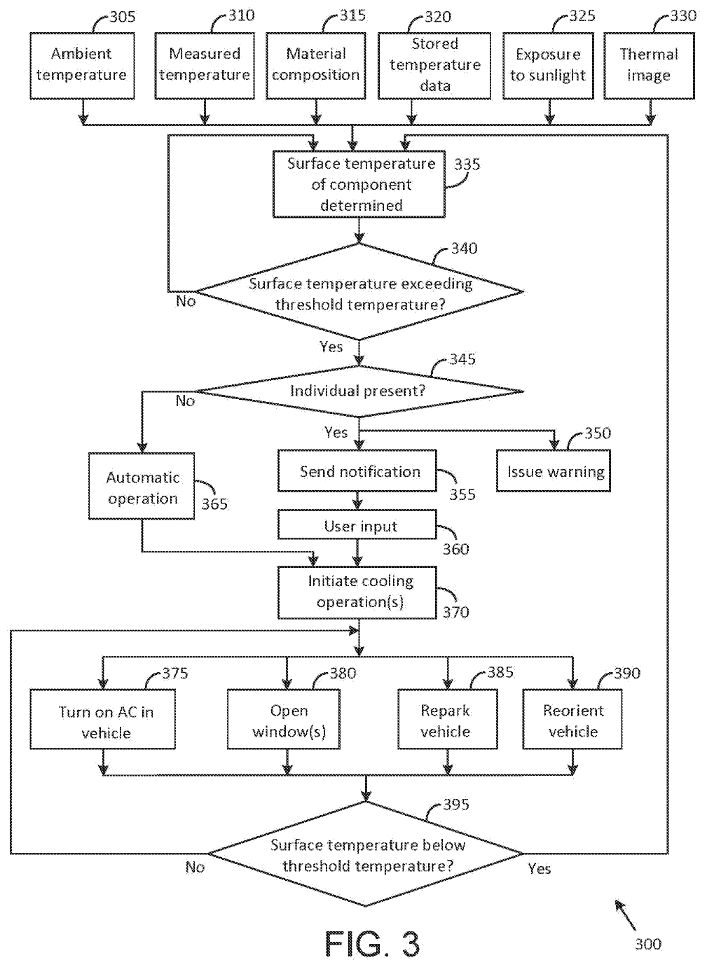

FIG. 3 illustrates a flowchart 300 of an example procedure to address a surface in a vehicle (such as the vehicle 105) that is uncomfortable to the touch in accordance with an embodiment of the disclosure. The flowchart 300 (and flowchart 700 described below) illustrates a sequence of operations that can be implemented in hardware, software, or a combination thereof. In the context of software, the operations represent computer-executable instructions stored on one or more non-transitory computer-readable media such as the memory 127, which, when executed by one or more processors such as the processor 126, perform the recited operations. More particularly, some or all of the computer-executable instructions can be embodied in the form of the surface temperature detection and notification system module 928 described herein.

Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. The various objects that are included in other figures are used below for purposes of description. However, it must be understood that the description is equally applicable to other objects in various other embodiments.

At block 335, a surface temperature of a component is determined. In an example scenario, a processor may execute the temperature measurement operation, the temperature estimation operation and/or the temperature prediction operation described above in order to determine a surface temperature of a component located on an exterior portion of the vehicle and/or a component located in a cabin area of the vehicle. The surface temperature may be determined by operating upon various types of information that may be obtained by the processor from various sensors and detectors. For example, a temperature sensor may provide a measurement of an ambient temperature around a component 305, a GPS device may provide location information 310 of the vehicle. A database may provide information such as, for example, a material composition 315 of the component (metal, plastic, rubber, etc.), stored temperature data 320 (historical data, for example), and an exposure to sunlight 325 (exposure period, expected time of further exposure, level of exposure. etc.). A thermal imaging camera can provide a thermal image 330 that includes the component.

At block 340, a determination is made whether the surface temperature of the component exceeds a threshold surface temperature. In an example scenario, the threshold surface temperature may be preset based on various factors. An example factor may be based on a classification of the component based on categories (first component category, second component category, etc. as described above). Another example factor may be based on a personal preference of an individual. Accordingly, for example, a driver of the vehicle may provide an indication of his/her preferences to the processor such as, for example, via a graphical user interface (GUI) of an infotainment system or via a software application in a personal device (smartphone, tablet computer, laptop computer etc.). In this scenario, a first driver may prefer to touch the component when the surface temperature of the component is at room temperature and a second driver may find it acceptable to touch the component when the surface temperature of the component is higher.

If, at block 340, the determination indicates that the surface temperature of the component does not exceed the threshold surface temperature, the operations indicated by block 335 and block 340 are executed in a recursive manner.

However, if, at block 340, the determination indicates that the surface temperature of the component exceeds the threshold surface temperature, at block 345 a determination is made whether an individual is present in the vicinity of the vehicle. In an example scenario, the determination may be made by the processor based on evaluating an image provided to the processor by a camera mounted on the vehicle. The processor may evaluate the image for various purposes, such as, for example, to determine an identity of the individual, to determine an association between the individual and the vehicle (driver, owner, passenger etc.), and/or to authenticate the individual for entry into the vehicle (to distinguish between a driver of the vehicle, for example, and a casual bystander, for example).

If, at block 345, the determination indicates that an individual is present in the vicinity of the vehicle, at block 350, a notification may be issued. The notification may be provided in various forms. For example, the notification may be provided in the form of a visual notification and/or in the form of an audible notification. The visual notification may be provided by the processor activating a light source such as, for example, the LED 147 associated with the door handle 145 of the vehicle 105. The audible notification may be provided by the processor activating an audio device associated with the component that is uncomfortable to the touch such as, for example, the LED 147 associated with the door handle 145 of the vehicle 105.

Furthermore, if, at block 345, the determination indicates that an individual is present in the vicinity of the vehicle, at block 355, a notification is sent to the individual. In an example implementation, the notification may be sent to the personal device 155 of the individual 150 who is present near the vehicle 105.

The notification can be provided in various forms. In one case, the notification may be provided in the form of a communication (text, email, image, speech synthesized announcement, etc.) via a software application provided in the personal device 155. An example notification can be a text that provides a notification that the component (the door handle 145 of the vehicle 105, for example) is uncomfortable to the touch. Another example notification can be a graphical rendering of the vehicle with the component(s) highlighted that are uncomfortable to the touch, such as, for example, in the form of a thermal map overlay on an outline of the vehicle (or a portion of the vehicle). Numerical temperature values and/or labels may also be shown associated with the highlighted portions so as to provide an indication of a level of surface temperature of the component. In an example implementation, the individual is provided with an option to silence, discontinue, or disregard the notification.

In yet another case, the notification may be provided in the form of a request or a query. An example request may seek permission and/or authorization for the processor to initiate cooling actions to cool the component. Another example query may be directed at obtaining a schedule for the processor to initiate cooling actions to cool the component. The schedule may be provided by the individual, based for example, on personal preferences, and may direct the processor to start cooling the component (a steering wheel of the vehicle, for example) at a specified time such as, for example, at a time prior to the individual arriving at the vehicle. Thus, for example, an officegoer can provide a schedule based on his/her working hours and driving habits.

In one example scenario, the vehicle has an internal combustion engine (ICE), and the query can be directed at inquiring whether the vehicle is parked in a well-ventilated area where the engine can be operated by the processor for activating an air-conditioning system of the vehicle for cooling the component (the steering wheel of the vehicle, for example).

In another example scenario, the vehicle is a battery electric vehicle (BEV). In this case, the query can pertain to items such as battery consumption, battery charge level, and acceptable level of battery discharge, and permission for the processor to operate an air-conditioning system of the vehicle.

At block 360, user input is received by the processor from the individual. The user input, can, for example, be a grant of permission to activate the air-conditioning system of the vehicle. In some example implementations, user input may be received in the form of gestures such as for example hand gestures or head gestures that indicate an approval to proceed with a cooling action. In some cases, user input may be received in the form of vocal commands. The various gestures and/or vocal commands may be interpreted by the processor using techniques such as facial recognition, voice recognition, artificial intelligence (AI), and machine-learning (ML).

At block 370, the processor initiates a cooling operation to cool the component. In one example scenario, the cooling operation is initiated upon receiving user input (block 360). In another example scenario, the cooling operation is initiated automatically (block 365) if, at block 345, it is determined that no one is present in the vicinity of the vehicle.

A cooling operation can be carried out by executing one or more actions such as, for example, turning on the air-conditioning system of the vehicle (block 375), partially or fully opening one or more windows of the vehicle (block 380), re-parking the vehicle (block 385) when the vehicle is an autonomous vehicle, and/or re-orienting the vehicle (block 390) when the vehicle is an autonomous vehicle.

Turning on the air-conditioning system of the vehicle by the processor can include operations such as, for example, operating upon one or more air-vents to direct airflow towards the surface of the component (to a touch screen of an infotainment system and/or towards the steering wheel, for example). In some cases, partially or fully opening one or more windows of the vehicle, may be accompanied by turning on a fan of the air-conditioning system and/or turning on the air-conditioning system. In some cases, the processor may execute window darkening techniques such as, for example, increasing a level of tinting and/or closing a sunshade of a window.

Re-parking the autonomous vehicle can involve the processor evaluating one or more images to identify a first parking spot that provides more shade than a second parking spot in which the autonomous vehicle is currently parked and moving the autonomous vehicle to the first parking spot. Re-orienting the autonomous vehicle can involve the processor moving and re-parking the autonomous vehicle (facing in an opposite direction, for example) so as to avoid or minimize an amount of sunlight falling upon the steering wheel, for example,

At block 395, a determination is made whether the surface temperature of the component has dropped below the threshold surface temperature. If the surface temperature has dropped below the threshold surface temperature, operations indicated in block 335 and subsequent blocks are carried out. If the surface temperature has not dropped below the threshold surface temperature, the processor continues to execute the cooling procedures to cool the component.

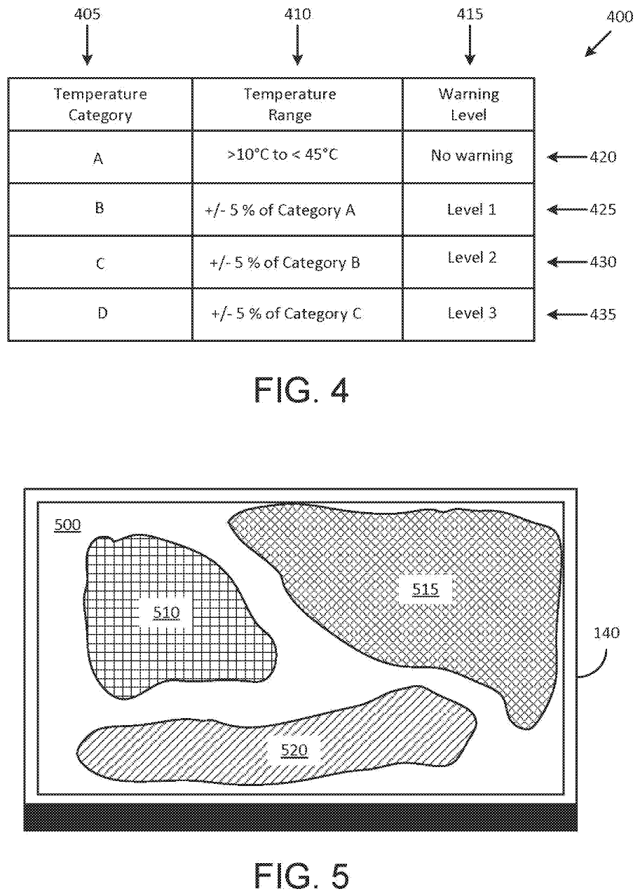

FIG. 4 shows an example table 400 of example temperature categories and notification levels in accordance with the disclosure. The table 400 may be stored in a database provided in the surface temperature detection and notification system 125 or elsewhere (such as, for example, in a server computer or cloud computer that is communicatively coupled to the surface temperature detection and notification system 125). The processor 126 of the surface temperature detection and notification system 125 may access the database and use the table 400 for various purposes such as, for example, to identify one of various cooling actions to be taken for cooling a surface of a component. A few example cooling actions have been described above with reference to the flowchart 300. The processor 126 may also use the table 400 for determining a notification level.

The example table 400 includes a column 405 showing four example temperature categories, column 410 showing four example temperature ranges corresponding to the four temperature categories, and column 415 shows four example notification levels corresponding to the four temperature categories.

A first row 420 indicates a category A having assigned, in an example implementation, a temperature range of (>10° C. to <45° C.), though this is merely illustrative of a range reflecting something that become uncomfortable to the touch. This range may be predetermined or set by the user, and stored as part of a user profile for implementation when the user is the operator of the vehicle, where different ranges may be used based on other user profiles. In an example implementation, no notification is issued when the surface temperature of a component corresponds to category A. The processor may refrain from initiating a cooling action to cool the component.

A second row 425 indicates a category B having assigned, in an example implementation, a temperature range that is +/−5% of temperature range A. This variance range may be predetermined or set by the user, stored as part of a user profile for implementation when the user is the operator of the vehicle, where different variance ranges may be used based on other user profiles. A level 1 notification may be issued when the surface temperature of a component corresponds to category B. The level 1 notification may be considered a low-level alert. The processor may initiate a low-level cooling action to cool the component such as, for example, partially opening a window of the vehicle.

A third row 430 indicates a category C having assigned, in an example implementation, a temperature range that is +/−5% of temperature range B. A level 2 notification may be issued when the surface temperature of a component corresponds to category C. The level 2 notification may be considered a medium-level alert. The processor may initiate a medium-level cooling action to cool the component such as, for example, activate a fan of a climate control system of the vehicle.

A fourth row 435 indicates a category D having assigned, in an example implementation, a temperature range that is +/−5% of temperature range C. A level 3 notification may be issued when the surface temperature of a component corresponds to category D. The level 2 notification may be considered a high-level alert. The processor may initiate a high-level cooling action to cool the component such as, for example, to turn on an air-conditioning system of the vehicle. Additional actions such as, re-parking the vehicle and/or re-orienting the vehicle may also be carried out in these cases.

FIG. 5 shows an example thermal map 500 in accordance with an embodiment of the disclosure. In an example implementation, the thermal map 500 is displayed upon a display screen of the infotainment system 140. In one case, the thermal map 500 can correspond to an exterior surface of a component of the vehicle 105 such as, for example, a touch screen of the infotainment system 140. In another case, the thermal map 500 can correspond to a portion of the vehicle 105 such as, for example, a door of the vehicle 105. The thermal map 500 corresponding to the door of the vehicle 105 can provide information about the surface temperature of various components such as, for example, a door handle and a door jamb.

In this example, the thermal map 500 indicates a first area 510 having a temperature that corresponds to category B described above. A second area 515 has a temperature that corresponds to category C described above. A third area 520 has a temperature that corresponds to category D described above. In an example implementation, the various areas may be highlighted in various colors based on the temperature values.

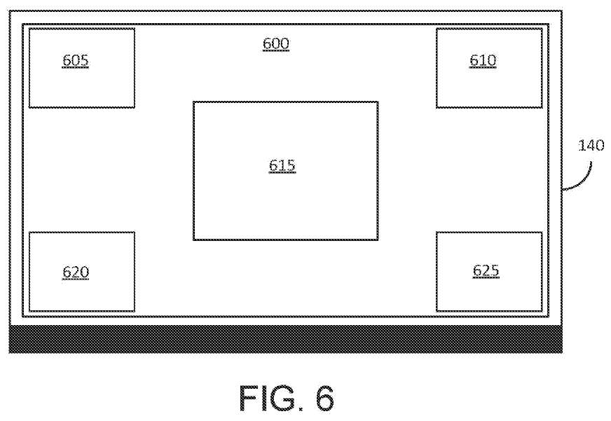

FIG. 6 shows an example zone assignment feature applied to a touch screen 600 of the infotainment system 140 in accordance with the disclosure. The processor 126 of the surface temperature detection and notification system 125 may assign one or more zones either in an autonomous manner or based on user input, and use the assigned zones for various purposes such as, for example, to identify areas of the touch screen 600 that are touched at various times and at various frequencies (occasionally, frequently, very frequently, etc.). The processor 126 may then evaluate each of the assigned zones to determine a surface temperature in the zone and perform various cooling actions to cool the touch screen with particular emphasis on the assigned zones.

The illustrated touch screen 600 has five assigned zones, one zone in each corner (zone 605, zone 610, zone 620, and zone 625) and one zone in a central area of the touch screen 600 (zone 615). The five zones may be assigned on the basis of various factors such as, for example, a touch characteristic (times, frequency, etc.) and a heating characteristic. In one case, the heating characteristic may be dependent on factors such as sunlight exposure, heat generated by the device (the infotainment system 140, in this example), and location of heat sources (electronics inside the infotainment system 140, for example) and heat transfer elements (cabinet of the infotainment system 140, for example).

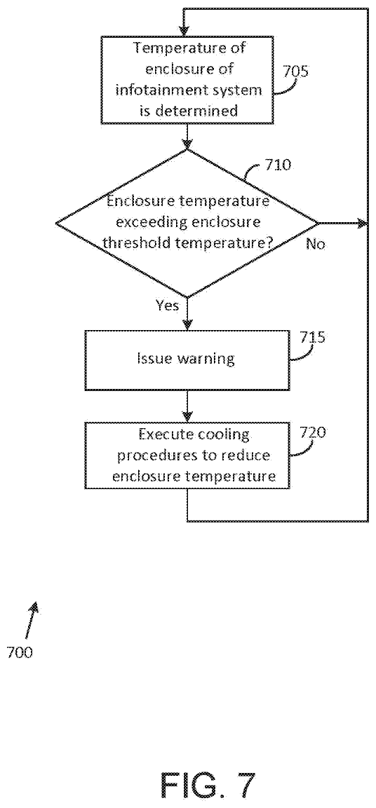

FIG. 7 illustrates a flowchart 700 of an example procedure to address a surface of an enclosure of an infotainment system in a vehicle that are uncomfortable to the touch in accordance with an embodiment of the disclosure. The flowchart 700 is described below with reference to an enclosure of an infotainment system such as, for example, the infotainment system 140 provided in the vehicle 105. However, it must be understood that flowchart 700 is equally applicable to an enclosure of any device in a vehicle that may be exposed to a heat source (such as for example, exposed to sunlight).

At block 705, a temperature of an enclosure of the infotainment system is determined. The temperature of the enclosure may be dependent on various factors such as, for example, an amount of sunlight that is incident upon the vehicle (particularly upon a portion of the vehicle where the infotainment system is located) and an operating condition of the infotainment system (whether the infotainment system is currently powered up—clock function in an on state, radio turned on, etc.).

At block 710, a determination is made whether the temperature of the enclosure exceeds an enclosure threshold temperature. In an example scenario, the enclosure threshold temperature may be preset based on various factors. A first example factor may be based on a material of the enclosure (metal, plastic, etc.). A second example factor may be based on a level of heat transfer between the enclosure and the touch screen of the infotainment system. The level of heat transfer may be determined using any of various empirical, theoretical, statistical, historical data, predictive, AI, ML procedures. A third example factor may be based on an amount of heat generated by electrical and/or electronic components housed inside the enclosure. A fourth example factor may be based on a mounting characteristic of the infotainment system in the vehicle (part of the enclosure exposed to the cabin area, air circulation around enclosure, air gap between enclosure and an adjacent component, etc.).

If the temperature of the enclosure does not exceed the enclosure threshold temperature, the operations indicated in block 705 and block 710 are repeated recursively.

However, if the temperature of the enclosure exceeds the enclosure threshold temperature, at block 715, a notification is issued. The notification can be issued in various ways such as in the form of the example notifications described above.

At block 720, one or more cooling procedures may be executed to cool the enclosure. Some example cooling procedures have been described above (turning on the air-conditioning system of the vehicle, partially or fully opening one or more windows of the vehicle, re-parking the vehicle, and/or re-orienting the vehicle).

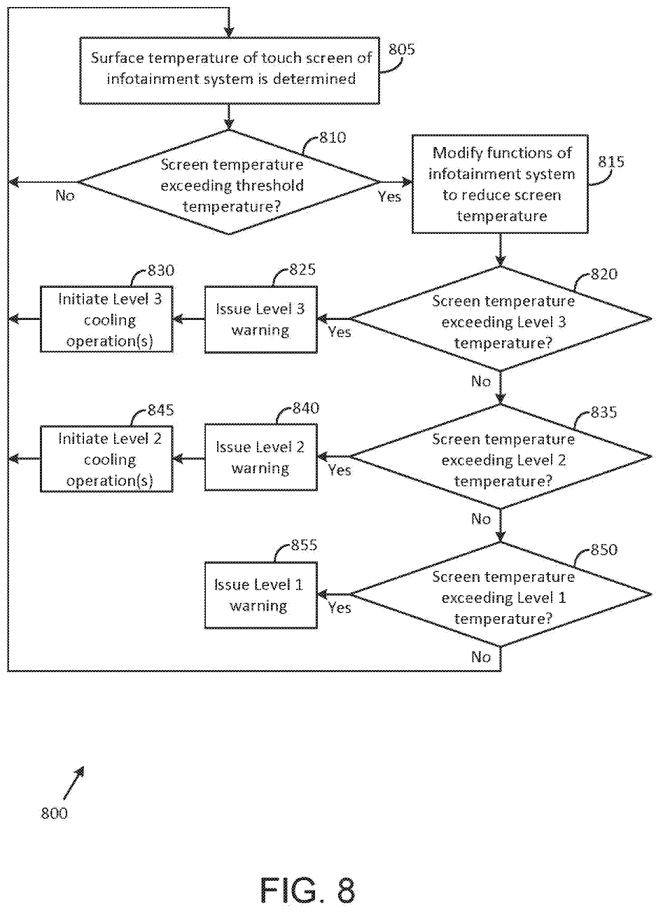

FIG. 8 illustrates a flowchart 800 of an example procedure to address a display screen of an infotainment system in a vehicle that are uncomfortable to the touch in accordance with an embodiment of the disclosure. The flowchart 700 is described below with reference to a touch screen of the infotainment system 140 provided in the vehicle 105. However, it must be understood that flowchart 800 is equally applicable to a display screen of any device in a vehicle that may be exposed to a heat source (such as for example, exposed to sunlight).

Furthermore, in one example implementation, the actions indicated in the flowchart 800 may be executed after execution of actions indicated in the flowchart 700 (described above). The sequential implementation of flowchart 800 after flowchart 700 may be applicable in at least some cases, where the temperature of the enclosure affects the temperature of the display screen. For example, cooling the enclosure of the infotainment system 140 may, in at least some cases, reduce a surface temperature of the display screen of the infotainment system 140 housed in the enclosure.

In another implementation, the actions indicated in the flowchart 800 may be executed concurrently or at a different time with respect to actions indicated in the flowchart 700.

At block 805, a surface temperature of a touch screen of the infotainment system is determined. The temperature of the touch screen may be dependent on various factors such as, for example, an amount of sunlight that is incident upon the vehicle (particularly upon a portion of the vehicle where the infotainment system is located) and an operating condition of the infotainment system (whether the infotainment system is currently powered up—clock function in an on state, radio turned on, etc.).

At block 810, a determination is made whether the temperature of the touch screen exceeds a screen threshold temperature. In an example scenario, the screen threshold temperature may be preset to a temperature value that exceeds the temperature range of temperature category D shown in table 400 and described above.

If the temperature of the display screen does not exceed the screen threshold temperature, the operations indicated in block 805 and subsequent blocks are carried out.

However, if the temperature of the touch screen exceeds the screen threshold surface temperature, at block 815, one or more functions and/or features of the infotainment system may be modified or disabled in order to reduce the screen temperature. Some of the functions may be modified based on determining a rate of change of temperature and/or a temperature gradient of the touch screen. One example function that may be modified is a brightness level of the touch screen if the touch screen is currently in operation. The brightness level may be reduced relative to an ambient level of light present around the infotainment system and/or amount of light incident upon the touch screen. The surface temperature may also be reduced by shutting down low priority software applications, shutting down unused applications, and/or disabling some features (videos, for example). In some cases, actions associated with modifying and/or disabling functions/features may be carried out on an interactive basis with a user of the infotainment system (seeking permission, seeking input, etc.).

At block 820, a determination is made whether the temperature of the touch screen now exceeds a first threshold temperature level, which, in one example implementation, can correspond to the temperature category D shown in table 400 of FIG. 4 that is described above.

If at block 820 it is determined that the temperature of the touch screen exceeds the first threshold temperature level, at block 825, a level 3 notification is issued. The level 3 notification is described above with reference to table 400.

At block 830, cooling operations commensurate with the level 3 notification are initiated. An example cooling operation may involve turning on the air-conditioning system of the vehicle to a high level and combining this action with one or more other actions such as opening windows, darkening windows, and providing an advisory to turn off the infotainment system (if the infotainment system is on).

If at block 820 the temperature of the touch screen does not exceed the first threshold temperature level, at block 835, a determination is made whether the temperature of the touch screen exceeds a second threshold temperature level, which, in one example implementation, can correspond to the temperature category C shown in table 400 of FIG. 4.

If the temperature of the touch screen exceeds the second threshold temperature level, at block 840, a level 2 notification is issued. The level 2 notification is described above with reference to table 400.

At block 845, cooling operations commensurate with the level 2 notification are initiated. An example cooling operation may involve turning on the fan of the air-conditioning system of the vehicle (without turning on the air-conditioning system) and partially opening one or more windows of the vehicle.

If at block 835, it is determined the temperature of the touch screen does not exceed the second threshold temperature level, at block 850, a determination is made whether the temperature of the touch screen exceeds a third threshold temperature level, which, in one example implementation, can correspond to the temperature category B shown in table 400 of FIG. 4. that is described above.

If the temperature of the touch screen exceeds the third threshold temperature level, at block 855, a level 1 notification is issued. The level 1 notification is described above with reference to table 400.

If, at block 850, it is determined that the temperature of the touch screen does not exceed the third threshold surface temperature level, the actions indicated at block 805 and subsequent blocks are carried out.

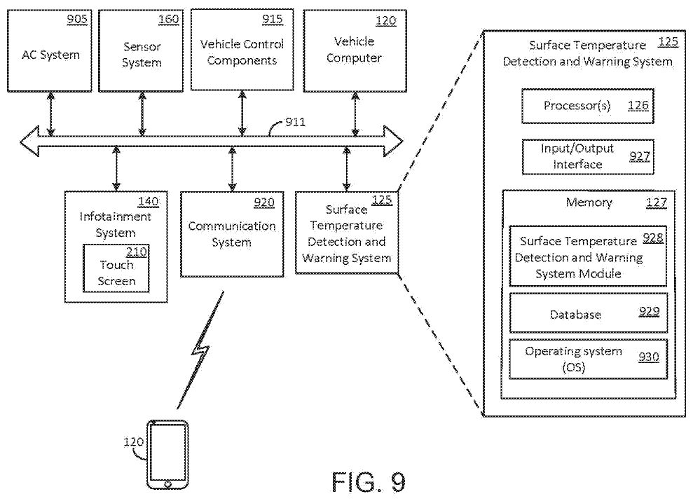

FIG. 9 shows some example components that can be included in the vehicle 105 in accordance with an embodiment of the disclosure. The example components can include an air-conditioning system 905, the sensor system 160, vehicle control components 915, the vehicle computer 120, the infotainment system 140, a communication system 920, and the surface temperature detection and notification system 125. The various components are communicatively coupled to each other via one or more buses such as an example bus 911. The bus 911 may be implemented using various wired and/or wireless technologies. For example, the bus 911 can be a vehicle bus that uses a controller area network (CAN) bus protocol, a Media Oriented Systems Transport (MOST) bus protocol, and/or a CAN flexible data (CAN-FD) bus protocol. Some or all portions of the bus 911 may also be implemented using wireless technologies such as Bluetooth®, Bluetooth®, Ultra-Wideband, Wi-Fi, Zigbee®, or near-field-communications (NFC).

The sensor system 160 can include one or more of various types of devices that are configured to sense, detect, determine, and/or measure the temperature of various components of the vehicle 105. In an example implementation, the sensor system 160 can include a thermocouple, a thermistor, a semiconductor integrated circuit (IC) sensor, and/or a thermometer. Such devices can be mounted adjacent to, or integrated into, various components of the vehicle 105. Thus, for example, a thermistor may be arranged in contact with the touch screen 210 of the infotainment system 140 for measuring a surface temperature of the touch screen 210. The surface temperature information may be conveyed to the surface temperature detection and notification system 125 through the bus 911.

In another example implementation, the sensor system 160 can include one or more cameras such as, for example, a digital camera, a video camera, and/or a thermal imaging device. An example of a thermal imaging device is a thermal imaging camera 170 that is shown in FIG. 1. The thermal imaging camera 170 may be mounted at various other locations on the vehicle 105, including, at locations suitable for capturing thermal images of exterior portions of the vehicle 105 (doors, trunk, hood, etc.). The thermal images can be conveyed to the surface temperature detection and notification system 125 through the bus 911. The surface temperature detection and notification system 125 may evaluate the thermal images to determine a surface temperature of a component of the vehicle 105 such as, for example, to determine a surface temperature of the touch screen 210 of the infotainment system 140.

The sensor system 160 can also include various devices configured to capture various types of information such as, for example, a device that detects an ambient temperature outside the vehicle 105, a device that detects an ambient temperature in the vicinity of a component, a device that obtains location information of a parking spot in which the vehicle 105 may be parked, and a device that obtains sunlight exposure information (direct exposure, in shade, length of time of exposure, etc.). Ambient temperature outside the vehicle 105 may be dependent on various factors such as, for example, a time of day, a season of the year, local weather, temperature in the vicinity of the vehicle 105, and weather conditions at a location where the vehicle 105 is parked (sunny, rainy, cloudy, etc.).

The vehicle control components 915 can include various components and systems associated with driving-related functions of the vehicle 105 as well as with functions that are associated with the surface temperature detection and notification system 125. Some example driving-related functions can include the operation of various vehicle components (engine, brakes, accelerator, fuel injection, etc.), and actions such as collision avoidance, automatic braking, and cruise control. The vehicle control components 915 may be controlled, activated, and/or operated by the vehicle computer 120. In some cases, some of the vehicle control components 915 may be controlled, activated, and/or operated by the surface temperature detection and notification system 125. For example, the surface temperature detection and notification system 125 may utilize some of the vehicle control components 915 to direct airflow provided by a fan of the air-conditioning system 905, towards a surface of a component for reducing the surface temperature of the component.

The infotainment system 140 can include the touch screen 210 described above. The touch screen 210 may be used by the surface temperature detection and notification system 125 to display various types of messages and notification(s) pertaining to the surface temperature of one or more components of the vehicle 105 (such as, for example, for displaying the notification shown in table 400 of FIG. 4). The touch screen 210 may also be used by a driver of the vehicle 105 to interact with the surface temperature detection and notification system 125 for various purposes such as, for example, to submit personal preferences associated with levels of surface temperatures.

The communications system 920 is configured to provide communications between the surface temperature detection and notification system 125 and various devices such as, for example, the personal device 155 carried by the individual 150 (shown in FIG. 1).

The surface temperature detection and notification system 125 can be implemented in various ways. In an example implementation, the surface temperature detection and notification system 125 can be an independent device (enclosed in an enclosure, for example). In another example implementation, some or all components of the surface temperature detection and notification system 125 can be housed, merged, or can share functionality, with the vehicle computer 120. For example, an integrated unit that combines the functionality of the surface temperature detection and notification system 125 with that of the vehicle computer 120 can be operated by a single processor and a single memory device. In the illustrated example configuration, the surface temperature detection and notification system 125 includes the processor 126, an input/output interface 927, and a memory 127.

The input/output interface 927 is configured to provide communications between the surface temperature detection and notification system 125 and other components coupled to the bus 911.

The memory 127, which is one example of a non-transitory computer-readable medium, may be used to store an operating system (OS) 930, a database 929, and various code modules such as, for example, a surface temperature detection and notification system module 928. The code modules are provided in the form of computer-executable instructions that can be executed by the processor 126 for performing various operations in accordance with the disclosure. More particularly, the surface temperature detection and notification system module 928 may be executed by the processor 126 for performing various operations in accordance with the disclosure. Some example operations are described above with reference to flowchart 300, flowchart 700, and flowchart 800. Execution of some of these operations can involve the surface temperature detection and notification system module 928 utilizing information stored in the database 929 (personal preferences, historical data, temperature information, weather information, etc.).

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions, such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device, such as the memory 127, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
determining, by a processor, a surface temperature of a component of a vehicle;
determining, by the processor, that the surface temperature of the component exceeds a threshold surface temperature; and
issuing, by the processor, a notification based on the surface temperature of the component exceeding the threshold surface temperature.

2. The method of claim 1, wherein determining the surface temperature comprises:
at least one of measuring the surface temperature of the component, estimating the surface temperature of the component, or predicting the surface temperature of the component.

3. The method of claim 2, wherein measuring the surface temperature of the component comprises obtaining a temperature measurement from a thermal sensor, wherein estimating the surface temperature of the component comprises at least one of evaluating a thermal image of at least a portion of the component, evaluating an ambient temperature, or evaluating sunlight exposure, and wherein predicting the surface temperature of the component comprises evaluating at least one of predicted weather information or historical vehicle parking information.

4. The method of claim 2, further comprising:
initiating, by the processor, a cooling operation to reduce the surface temperature of the component, the cooling operation comprising at least one of operating an air-conditioning system of the vehicle, directing an air flow upon the component, or opening a window of the vehicle.

5. The method of claim 1, wherein the threshold surface temperature is preset based on a classification of the component as belonging to a first component category, the first component category including a first set of components having a higher probability of being touched by an individual over a first period of time than a second set of components that are included in a second component category.

6. The method of claim 1, wherein issuing the notification comprises:
activating, by the processor, at least one of an audio transmitter, a first light source mounted upon the component, or a second light source mounted adjacent to the component.

7. The method of claim 1, wherein issuing the notification comprises:
displaying, by the processor, upon a display screen, at least one of a thermal map of an exterior surface of the component or a notification message.

8. The method of claim 7, wherein the component is an infotainment system, and wherein the thermal map is displayed upon the display screen of the infotainment system.

9. A method comprising:
determining, by a processor, a surface temperature of a component that is a part of a vehicle;
evaluating, by the processor, the surface temperature of the component; and
issuing, by the processor, a notification and/or an advisory based on evaluating the surface temperature of the component.

10. The method of claim 9, wherein determining the surface temperature comprises:
at least one of measuring the surface temperature of the component, estimating the surface temperature of the component, or predicting the surface temperature of the component.

11. The method of claim 9, wherein evaluating, by the processor, the surface temperature of the component comprises:
determining, by the processor, that the surface temperature corresponds to a first temperature category of a plurality of temperature categories; and
issuing, by the processor, the notification based on the surface temperature corresponding to the first temperature category.

12. The method of claim 11, wherein issuing the notification comprises at least one of displaying, by the processor, a notification message on a display screen, or activating, by the processor, at least one of an audio transmitter, a first light source mounted upon the component, or a second light source mounted adjacent to the component.

13. The method of claim 9, wherein the component is an infotainment system of the vehicle, and wherein the method further comprises:
evaluating, by the processor, the surface temperature of a touch screen of the infotainment system; and
displaying, by the processor, a thermal map upon the touch screen of the infotainment system, the thermal map indicating at least a first surface temperature of a first area of the touch screen and a second surface temperature of a second area of the touch screen.

14. The method of claim 13, wherein evaluating the surface temperature of the touch screen of the infotainment system comprises:
classifying, by the processor, the first surface temperature of the first area in one of a first temperature range or a second temperature range;
classifying, by the processor, the second surface temperature of the second area in one of the first temperature range or the second temperature range;
highlighting, by the processor, the first area in one of a first color or a second color based on classifying the first surface temperature in one of the first temperature range or the second temperature range; and
highlighting, by the processor, the second area in one of the first color or the second color based on classifying the second surface temperature in one of the first temperature range or the second temperature range.

15. A vehicle comprising:
a surface temperature detection and notification system comprising:
a memory that stores computer-executable instructions; and
a processor configured to access the memory and execute the computer-executable instructions to perform operations comprising:
determining a surface temperature of a component that is a part of the vehicle;
determining that the surface temperature exceeds a threshold surface temperature; and
issuing a notification and/or an advisory based on the surface temperature exceeding the threshold surface temperature.

16. The vehicle of claim 15, wherein determining that the surface temperature exceeds the threshold surface temperature comprises at least one of measuring the surface temperature of the component, estimating the surface temperature of the component, or predicting the surface temperature of the component.

17. The vehicle of claim 16, wherein measuring the surface temperature of the component comprises obtaining a temperature measurement from a thermal sensor, wherein estimating the surface temperature of the component comprises at least one of evaluating a thermal image of at least a portion of the component, evaluating an ambient temperature, or evaluating sunlight exposure, and wherein predicting the surface temperature of the component comprises evaluating at least one of predicted weather information or historical vehicle parking information.

18. The vehicle of claim 15, wherein issuing the notification comprises at least one of displaying, by the processor, a notification message on a display screen, or activating, by the processor, at least one of an audio transmitter, a first light source mounted upon the component, or a second light source mounted adjacent to the component.

19. The vehicle of claim 15, wherein the processor is further configured to access the memory and execute additional computer-executable instructions to at least:
initiate a cooling operation to reduce the surface temperature of the component, the cooling operation comprising at least one of operating an air-conditioning system of the vehicle, directing an air flow upon the component, or opening a window of the vehicle.

20. The vehicle of claim 15, wherein the component is one of a steering wheel, a seat, a drive selector, an infotainment system, a console, a switch, a button, a door handle, a trunk handle, or a mirror.
